(19) United States
(12) Patent Application Publication
(10) Pub. No.: US 2006/0225576 A1
(43) Pub. Date: Oct. 12, 2006

(54) Beverage making device having protrusions at the upper wall of the brewing chamber

(76) Inventor: Bernardus Petrus Gerardus D'Hont, Hoogeveen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/568,374

(22) PCT Filed: Jul. 30, 2004
(86) PCT No.: PCT/IB04/51337

§ 371 Date: Feb. 14, 2006

(30) Foreign Application Priority Data
Aug. 18, 2003 (EP) 03102580.2

(51) Int. Cl. A47J 31/00

(52) U.S. Cl. 99/279

(57) ABSTRACT

A beverage making device comprising a brewing chamber (5) for enclosing a pad containing a substance from which the beverage is brewed. The brewing chamber (5) has an upper wall (4) with one or more holes through which heated water can enter the brewing chamber (5). The upper wall (4) can hinge from a substantially horizontal brewing position in which the upper wall (4) is a portion of the wall of the brewing chamber (5) into an open position in which the pad can be removed from the brewing chamber (5). A substantial portion of the surface of said upper wall (4) is provided with protrusions (21). The protrusions have a height of more than 0.5 mm, and the distance between every two neighboring protrusions (21) is less than 12 mm.

The invention relates to a beverage making device comprising a brewing chamber for enclosing a pad containing a substance from which the beverage is brewed, the brewing chamber having an upper wall with one or more holes through which heated water can enter the brewing chamber, which upper wall can hinge from a substantially horizontal brewing position, in which the upper wall is a portion of the wall of the brewing chamber into an open position in which the pad can be removed from the brewing chamber.

Such a device is described in WO-A-01/15582. The described device comprises a water reservoir and means for heating the water and pumping it towards the holes in the upper wall of the brewing chamber, so that the heated water will enter the brewing chamber under pressure. The brewing chamber is filled with a pad containing a substance, for example ground coffee, and the heated water will pass through the pad, so that the coffee is extracted. After the extraction process, the liquid (coffee) leaves the brewing chamber through an outflow opening in the bottom of the brewing chamber and arrives in a liquid receiving chamber. The liquid receiving chamber comprises an outflow tube extending outside the device, so that the brewed liquid (coffee) can be caught by one or by two cups. The portion of the device comprising the upper wall of the brewing chamber can hinge upwards with respect to the stationary part of the brewing chamber to give access to the brewing chamber, so that a new pad can be placed for a next extraction process. In the upward position of said portion, the part of the device comprising the side wall and the lower wall of the brewing chamber (said stationary part) and the liquid receiving chamber can be removed from the device, for example for cleaning that part or for replacing the part by another, similar part in which the brewing chamber is larger, so that two pads can be placed in it in order to brew enough beverage for two cups instead of one cup.

A beverage can be made in an extraction process by means of the device, for example to produce coffee, or in a dissolving process, for example to produce a chocolate drink. In the case of an extraction process, the extracted substance will remain in the pad and the pad with the extracted substance must be removed from the chamber afterwards. In the case of a dissolving process, the substance in the pad will disappear during the brewing process, and the empty pad must be removed.

It was found in practice that the wet pad tends to stick to the upper wall when that upper wall is hinged into its open position. This is especially the case when two pads are placed in the brewing chamber: the upper pad then sticks to the upper wall, while the lower pad remains in the stationary part of the brewing chamber. Of course the pad can be removed by hand from the upper wall in its open position, but it is easier to remove the pad or the pads from the stationary part of the brewing chamber. Furthermore, the user of the device expects the pad to remain in the stationary part when he or she opens the brewing chamber and therefore may not notice a pad sticking to the upper wall.

The object of the invention is to provide a beverage making device as described above wherein the pad or, if two pads are present, both pads always remain in the stationary part of the brewing chamber when that chamber is opened.

To accomplish that objective, a substantial portion of the surface of said upper wall is provided with protrusions having a height of more than 0.5 mm, the distance between every two neighboring protrusions being less than 12 mm, preferably less than 10 mm. Said substantial portion preferably accounts for more than 50% of the surface area of said upper wall, and in a preferred embodiment more than 75%. The protrusions may have the form of studs having more or less a cylindrical shape. The protrusions prevent the pad from sticking to the upper wall when the upper wall is hinged upward.

The device disclosed in WO-A-01/15582 is provided with six protrusions at the surface of the upper wall of the brewing chamber, which protrusions are located at considerable distances from each other. It was found in practice that the pad tends to stick to the hinging upper wall in the disclosed device, despite the presence of the protrusions. However, the tendency to stick can be decreased when certain dimensions of the protrusions are applied.

In one preferred embodiment, the distance between every two neighboring protrusions is less than 6 mm, and preferably the height of the protrusions is more than 0.7 mm, more preferably more that 1 mm.

In one preferred embodiment, the transverse section of the protrusions (i.e. the section parallel to the plane of the upper wall) is substantial circular, with a diameter between 0.5 mm and 3 mm, preferably between 1 mm and 2 mm.

Preferably, the distance between every two neighboring protrusions is less than eight times the height of the protrusions, preferably less than five times the height of the protrusions. The higher the protrusions, the greater the distance between the protrusions can be.

In one preferred embodiment, at least a portion of the side wall of a protrusion extends at an angle of more than 60°, preferably more than 75°, relative to the plane of said upper wall, and preferably a portion of each protrusion is substantial cylindrical.

In another preferred embodiment, the protrusions are ribs on the surface of the upper wall. These may be straight ribs, but the ribs may also be concentrically circular ribs. The ribs may also have the shape of circular arcs or the like.

To achieve a good access to the brewing chamber when that chamber is opened, said upper wall can hinge through more than 60°, preferably more than 70°, more preferably more than 80°.

In one preferred embodiment, a removable part comprising the part of the wall of the brewing chamber other than said upper wall is a portion of a removable part, and said removable part can be taken from the device in order to clean the brewing chamber or to remove the pad.

The invention also relates to a method of making a beverage by means of a beverage making device, wherein a pad containing a substance from which the beverage is to be brewed is placed in a brewing chamber, the brewing chamber having an upper wall with one or more holes through which heated water enters the brewing chamber, wherein said upper wall is hinged after the brewing process from a substantially horizontal brewing position in which the upper wall is a portion of the wall of the brewing chamber into an open position in which the pad can be removed, wherein a substantial portion of the surface of said upper wall is provided with protrusions having a height of more than 0.5 mm, and wherein the distance between every two neighboring protrusions is less than 12 mm, so that the pad will remain in the brewing chamber when the upper wall is hinged into its open position.

The invention will now be explained by means of a description of an embodiment of a device for making coffee, in which reference is made to the drawing, in which:

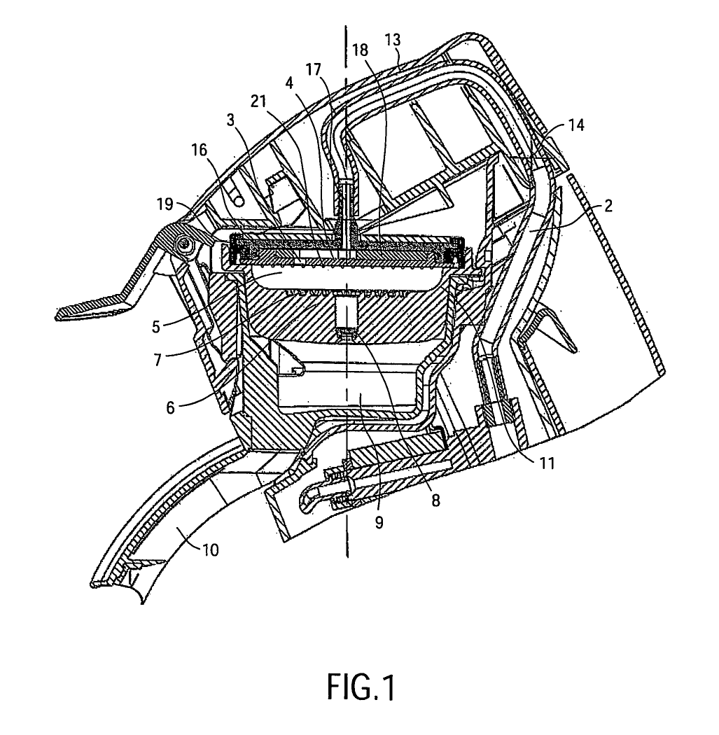

FIG. 1 is a sectional view of a portion of the device,

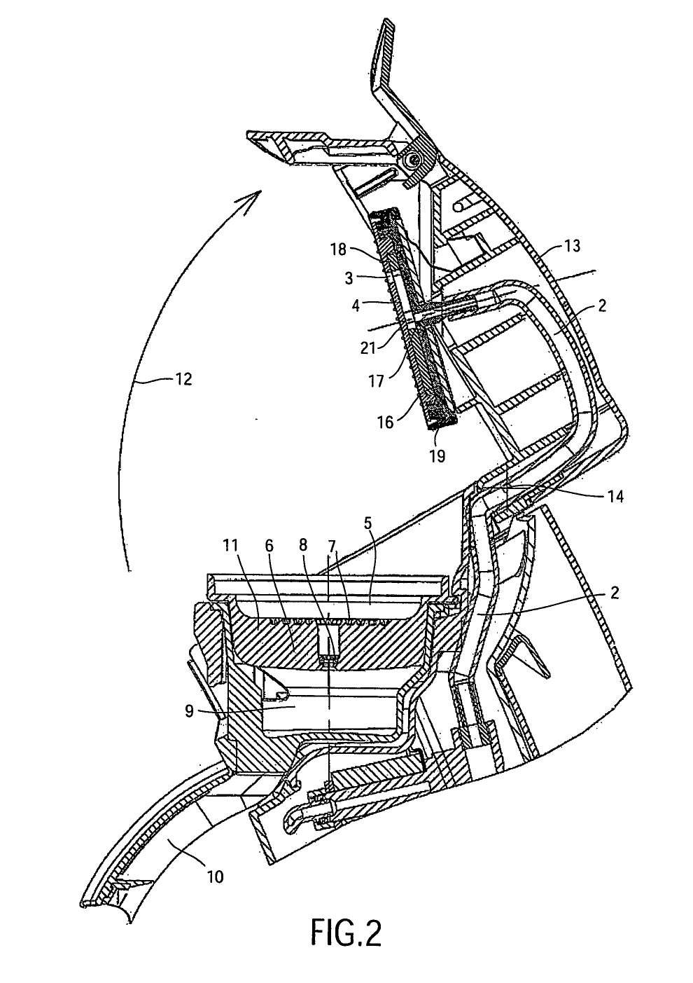

FIG. 2 shows the device with the brewing chamber in open position,

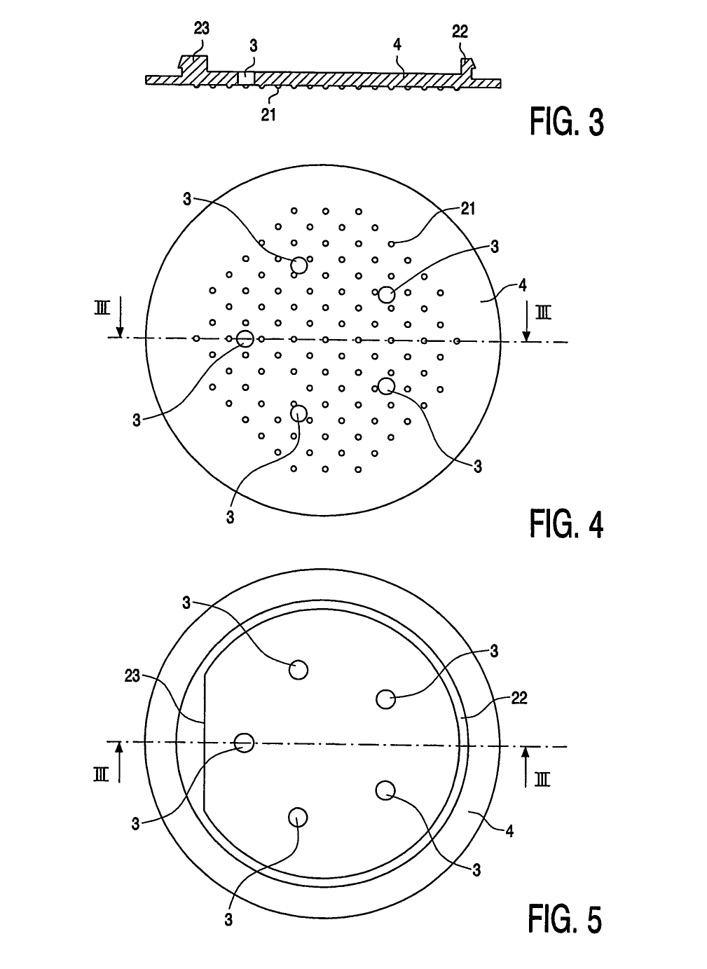

FIG. 3 is a sectional view of the upper wall of the brewing chamber,

FIG. 4 is a bottom view of the upper wall according to FIG. 3, and

FIG. 5 is a top view of the upper wall according to FIG. 3.

FIG. 1 shows the relevant portion (i.e. the uppermost portion) of a device for making coffee. The other portion of the device, which is not shown, comprises a water container and means for heating the water and pumping a predetermined quantity of the heated water through tube 2 to five holes 3 in the upper wall 4 of the brewing chamber 5. In the sectional view of FIG. 1, only one hole 3 in the upper wall 4 is shown. Brewing chamber 5 has a substantial cylindrical shape, and a disc-like pad (not shown) containing, for example, ground coffee fits in said chamber.

The lower wall 6 of the brewing chamber 5 is provided with a profile 7 so as to form channels for allowing the brewed coffee to arrive at the central part of the bottom of the brewing chamber 5, so that the liquid can flow to the outflow opening 8 in the lower wall 6. The brewed coffee is collected in a liquid receiving chamber 9 and subsequently guided through two outflow tubes 10 extending outside the device to a location where the brewed coffee can be caught by one or by two cups (not shown). There are two outflow tubes 10 parallel to each other, so that each outflow tube 10 can guide brewed coffee to one of two cups, which cups stand near each other. If only one cup is to be filled, both outflow tubes 10 will guide the brewed coffee to the same cup. Since the two outflow tubes 10 are located on either side of the plane of drawing, they are not visible in the sectional views of FIG. 1 and FIG. 2.

The brewing chamber 5 as shown in FIG. 1 has a dimension to accommodate a pad containing ground coffee for brewing coffee for one cup. If two cups of coffee are to be brewed, the part 11 of the device can be replaced by another part 11, which other part (not shown) comprises a thinner lower wall 6, so that the height of the brewing chamber 5 is increased and the brewing chamber 5 can accommodate two pads containing ground coffee, or a bigger pad, to brew enough coffee for two cups.

As is shown in FIG. 2 by arrow 12, the device can be opened by hinging the upper part 13 of the device about an axis 14. The upper wall 4 of the brewing chamber 5 is connected to said upper part 13, so that the brewing chamber 5 becomes accessible after opening. A used pad may then be removed and/or a new pad may be placed in the brewing chamber 5. If the next brewing process is to be performed with two pads, the open position of the brewing chamber allows the replacement of part 11 of the device by another one having a larger brewing chamber 5. To enable the hinging movement of the upper part 13, the tube 2 is made of a flexible material.

In the opened position of the device as shown in FIG. 2, the part of the device comprising the brewing chamber 5 (except for its upper wall 4), the liquid receiving chamber 9, and the outflow tubes 10 is removable from the device, so that the part can be cleaned.

The upper wall 4 of the brewing chamber 5 has a disc-like shape and is clamped in a connecting piece 16 comprising a central water duct 17 which is connected to tube 2, as is shown in FIGS. 1 and 2. Between the upper wall 4 and the connecting piece 16 there is a distribution plate 18, having a disc-like shape and comprising recesses in the material to guide the heated water coming from the tube 2 and the water duct 17 to the five holes 3 in the upper wall 4. Around the connecting piece 16 there is a sealing ring 19 to provide a watertight sealing between the removable part 11 and the upper wall 4 when the brewing chamber 5 is closed (FIG. 1).

At the lower side of the upper wall 4, the main portion of the surface of the upper wall 4 is provided with protrusions 21. In this example, the height of the protrusions 21 is about 1 mm, and the distance between the protrusions 21 is about 4 mm.

FIG. 3 is the same sectional view of the upper wall 4 of the brewing chamber 5 as is shown in FIGS. 1 and 2, but on a larger scale. The upper wall 4 is made of a synthetic resin material. At its upper side, the upper wall 4 is provided with an annular protrusion 22 which can surround the distribution plate 18 and which clamps in the connecting piece 16.

FIG. 4 is a view of the lower side of the upper wall 4 and shows the distribution of the protrusions 21 over the lower side of the upper wall 4. FIG. 4, and also FIG. 5, furthermore show the locations of the five holes 3 in the upper wall 4.

FIG. 5 is a view of the upper side of the upper wall 4. The annular protrusion 22 is provided with a flat (straight) portion 23 corresponding to a flat portion at the edge of distribution plate 18, so that said distribution plate fits between the upper wall 4 and the connecting piece 16 in one position only.

The protrusions 21 at the lower side of the upper wall 4 of the brewing chamber 5 achieve that the wet pad will not stick to the upper wall 4 when the brewing chamber 5 is opened.

The embodiment as described above is only an example; a great many other embodiments are possible, including embodiments in which the protrusions 21 at the lower side of the upper wall 4 of the device have a different shape.

1. A beverage making device comprising a brewing chamber (5) for enclosing a pad containing a substance from which the beverage is brewed, the brewing chamber (5) having an upper wall (4) with one or more holes (3) through which heated water can enter the brewing chamber (5), which upper wall (4) can hinge from a substantially horizontal brewing position in which the upper wall (4) is a portion of the wall of the brewing chamber (5) into an open position in which the pad can be removed from the brewing chamber (5), characterized in that a substantial portion of the surface of said upper wall (4) is provided with protrusions (21) having a height of more than 0.5 mm, the distance between every two neighboring protrusions (21) being less than 12 mm.

2. A beverage making device as claimed in claim 1, characterized in that the distance between every two neighboring protrusions (21) is less than 6 mm.

3. A beverage making device as claimed in claim 1, characterized in that the height of the protrusions (21) is more than 0.7 mm, preferably more than 1 mm.

4. A beverage making device as claimed in claim 1, characterized in that the transverse section of the protrusions (21) is substantial circular, with a diameter between 0.5 mm and 3 mm, preferably between 1 mm and 2 mm.

5. A beverage making device as claimed in claim 1, characterized in that the distance between every two neighboring protrusions (21) is less than eight times the height of the protrusions (21), preferably less than five times the height of the protrusions (21).

6. A beverage making device as claimed in claim 1, characterized in that at least a portion of the side wall of a protrusion (21) extends at an angle of more than 60°, preferably more than 75°, relative to the plane of said upper wall (4).

7. A beverage making device as claimed in claim 1, characterized in that a portion of each protrusion (21) is substantially cylindrical.

8. A beverage making device as claimed in claim 1, characterized in that the protrusions (21) are ribs on the surface of the upper wall (4).

9. A beverage making device as claimed in claim 1, characterized in that said upper wall (4) can hinge through more than 60°, preferably more than 70°, more preferably more than 80°.

10. A beverage making device as claimed in claim 1, characterized by a removable part comprising the part of the wall of the brewing chamber (5) other than said upper wall (4), which removable part can be taken from the device in order to clean the brewing chamber (5) or to remove the pad.

11. A method of making a beverage by means of a beverage making device, wherein a pad containing a substance from which the beverage is to be brewed is placed in a brewing chamber (5), said brewing chamber (5) having an upper wall (4) with one or more holes (3) through which heated water can enter the brewing chamber (5), wherein said upper wall (4) is hinged after the brewing process from a substantially horizontal brewing position in which the upper wall (4) is a portion of the wall of the brewing chamber (5) into an open position in which the pad is removed, characterized in that a substantial portion of the surface of said upper wall (4) is provided with protrusions (21) having a height of more than 0.5 mm, the distance between every two neighboring protrusions (21) being less than 12 mm, so that the pad will remain in the brewing chamber (5) when the upper wall (4) is hinged into its open position.
